(19) United States
(12) Patent Application Publication
(10) Pub. No.: US 2013/0233781 A1
(43) Pub. Date: Sep. 12, 2013

(54) ULTRATHIN-LAYER CHROMATOGRAPHY PLATES COMPRISING ELECTROSPUN NANOFIBERS COMPRISING SILICA AND METHODS OF MAKING AND USING THE SAME

(71) Applicants: Susan Olesik, Columbus, OH (US); Toni Newsome, Columbus, OH (US)

(72) Inventors: Susan Olesik, Columbus, OH (US); Toni Newsome, Columbus, OH (US)

(21) Appl. No.: 13/796,706

(22) Filed: Mar. 12, 2013

Related U.S. Application Data
(60) Provisional application No. 61/609,620, filed on Mar. 12, 2012.

(51) Int. Cl. G01N 30/94; G01N 30/93

(52) U.S. Cl. CPC G01N 30/94; G01N 30/93
USPC 210/198.3; 264/7

(57) ABSTRACT

An ultrathin-layer chromatography plate having a stationary phase with electrospun nanofibers comprising silica, wherein the stationary phase has a thickness from about 10 μm to about 30 μm.

### CROSS-REFERENCE TO RELATED APPLICATIONS

This application claims priority to U.S. Provisional Patent Application No. 61/609,620, filed Mar. 12, 2012, which is incorporated herein in its entirety by reference.

### STATEMENT REGARDING FEDERALLY-SPONSORED RESEARCH

The present invention was made with Government support under at least one of the following grants awarded by U.S. National Science Foundation: Grant #0914790: Nanoscale Science and Engineering Center (NSEC) for Affordable Nanoengineering of Polymeric Biomedical Devices, and U.S. National Science Foundation: Grant #1012279 Toward Homogeneous Carbon Media for Separation Science. The United States Government may have certain rights to this invention under 35 U.S.C §200 et seq.

### BACKGROUND

Originally developed in the 1950s, thin layer chromatography (TLC), also called planar chromatography, is widely used today in environmental analysis, food, clinical, and pharmaceutical industries. See, C. F. Poole, The Essence of Chromatography, Elsevier Science, Amsterdam, The Netherlands, 2003; and J. Sherma, Anal. Chem. 82 (2010) 4895-4910, each of which is incorporated herein in its entirety by reference. The stationary phase in TLC consists of sorbent particles that are attached to a solid support, typically an aluminum or glass plate. The analytes of interest are spotted directly onto the stationary phase, the edge of which is brought into contact with the mobile phase. The mobile phase proceeds up the plate via capillary action. Separation of analytes occurs due to interactions with both the mobile phase and the stationary phase. A number of different materials have been applied as the stationary phase in TLC, including alumina, cellulose, ion-exchange resins and, perhaps most commonly, silica gel. See, J. S. Bernard Fried, Thin-layer Chromatography: Techniques and Applications, Marcel Dekker, New York, N.Y., 1994; L. W. Bezuidenhout, M. J. Brett, J. Chromatogr. A. 1183 (2008) 179-185; S. A. Nabi, M. A. Khan, Acta Chromatogr. 13 (2003) 161-171; and M. Macan-Kastelan, S. Cerjan-Stefanovic, A. Petrovic, Chromatographia, 27 (1989) 297-300, each of which is incorporated herein in its entirety by reference. More recently, nanostructured surfaces have been developed for TLC applications. See, J. Song, D. S. Jensen, D. N. Hutchison, B. Turner, T. Wood, A. Dadson, M. A. Vail, M. R. Linford, R. R. Vanfleet, R. C. Davis, Adv. Funct. Mater. 21 (2011) 1132-1139; and S. R. Jim, A. J. Oka, M. T. Taschuk, M. J. Brett, J. Chromatogr. A. 1218 (2011) 7203-7210, each of which is incorporated herein in its entirety by reference.

In 2001, ultra-thin layer chromatography (UTLC) was developed. This technology, which typically utilizes a stationary phase with a 5-30 μm thickness (compared to 100-400 μm thick stationary phases for commercial TLC devices), represented a significant improvement in analysis time and sensitivity over traditional TLC devices. See, Bezuidenhout et al. (2008); and H. E. Hauck, M. Schulz, Chromatographia Suppl. 57 (2003) S-313-S-315, which is incorporated herein in its entirety by reference. For some UTLC plates, electrospinning may be utilized to generate a mat of nanofibers that can be used as a UTLC sorbent. See, J. E. Clark, S. V. Olesik, Anal. Chem. 81 (2009) 4121-4130; J. E. Clark, S. V. Olesik, J. Chromatogr. A. 1217 (2010) 4655-4662; and U.S. Patent Application Pub. No. 2011/0214487, each of which is incorporated herein in its entirety by reference. Electrospinning is a cost effective method of generating nanofibers that includes placing a high electric field between a syringe containing a polymeric solution and a conductive surface. At a critical voltage, the surface tension of the polymer solution at the syringe tip is overcome, and polymeric nanofibers are splayed from the droplet and are collected on the conductive surface. See, S. Ramakrishna, K. Fujihara, W. E. Teo, T. C. Lim, Z. Ma, An Introduction to Electrospinning and Nanofibers, World Scientific, River Edge, N.J., 2005, which is incorporated herein in its entirety by reference. To date, electrospinning has been used in a variety of applications including use in sensors, tissue scaffolds, and in solid phase microextraction. See, W. G. Shim, C. Kim, J. W. Lee, J. J. Yun, Y. Jeong, H. Moon, K. S. Yang, J. Appl. Polym. Sci. 102 (2006) 2454-2462; U. Boudriot, R. Dersch, A. Greiner, J. H. Wendorff, Artif. Organs. 30 (2006) 785-792; J. W. Zewe, J. K. Steach, S. V. Olesik, Anal. Chem. 82 (2010) 5341-5348; and T. E. Newsome, J. W. Zewe, S. V. Olesik, J. Chromatogr. A. 1262 (2012) 1-7, each of which is incorporated herein in its entirety by reference.

Electrospun UTLC (E-UTLC) plates are particularly attractive for a number of reasons: no binder material is required in fabrication (see, Sherma (2010)); the solid support and mat thickness are readily variable; the small dimensions of the fibers provide a support with high surface area, and the chemical functionalities in the stationary phase can be easily modified. See, Clark (2009) and Clark (2010). Electrospun polyacrylonitrile (PAN) UTLC plates not only demonstrated a decreased time of analysis, but also vastly superior separation efficiencies for steroidal compounds relative to a commercially available cyano phase TLC plate. See, Clark (2009). Cyano-modified phases are frequently utilized as a stationary phase in the separation of steroidal compounds, as well as alkaloids and derivitized amino acids. See, W. Jost, H. E. Hauck, W. Fischer, Chromatographia, 21 (1986) 375-378, which is incorporated herein in its entirety by reference. The PAN E-UTLC plate demonstrated 500 times greater separation efficiency and a decreased time of analysis by up to 50% when compared to the conventional cyano TLC phase. See, Clark (2009).

Silica is the most commonly used surface for TLC stationary phases. See, Spangenberg et al., Quantitative Thin-Layer Chromatography; Springer Verlag: Heidelberg, Germany (2011); and Reich, E. and Schibli, A., High-Performance Thin-Layer Chromatography for the Analysis of Medicinal Plants; Thieme Medical Publications, Inc.: New York, N.Y. (2007), each of which is incorporated herein in its entirety by reference.

Electrospun silica-based nanofibers can be prepared using any of two main routes: the sol-gel technique or silica particles. The sol-gel technique involves the hydrolysis of a metal alkoxide, such as tetraethyl orthosilicate (TEOS), in alcohol and water under acidic conditions. See, Andrady, A. L. Science and Technology of Polymer Nanofibers; John Wiley & Sons, Inc.: Hoboken, N.J., (2008), which is incorporated herein in its entirety by reference. The sol-gel itself can be electrospun, but it is generally mixed with a polymer prior to electrospinning. One of the main drawbacks due to the nature of this method is that the morphology of the nanofibers varies dramatically with hydrolyzing time and thus with electrospinning time. See, Ma, Z.; Ji, H.; Teng, Y.; Dong, G.; Tan, D.; Guan, M.; Zhou, J.; Xie, J.; Qiu, J.; Zhang, M. J. Mater. Chem. (2011), 21, 9595-9602, which is incorporated herein in its entirety by reference. This variability would be highly undesirable for chromatographic stationary phases.

As described, the separation techniques of TLC have known impediments.

### SUMMARY

This disclosure provides ultrathin-layer chromatography plates comprising a stationary phase including electrospun nanofibers comprising silica. The electrospun nanofibers may comprise at least about 90% silica. The electrospun nanofibers may further comprise polyvinylpyrrolidone.

This disclosure also provides methods of making an ultrathin-layer chromatography plate having a stationary phase comprising nanofibers comprising silica. The nanofibers may comprise at least about 90% silica. The methods may comprise electrospinning a solution comprising polyvinylpyrrolidone and silica nanoparticles to form a mat comprising polyvinylpyrrolidone-silica composite nanofibers. The methods may comprise heat treating the mat to form the stationary phase. The solution may comprise from about 1 wt % to about 20 wt % polyvinylpyrrolidone and from about 1 wt % to about 15 wt % silica nanoparticles. The heat treating step may be performed at a temperature from about 100° C. to about 470° C. The heat treating step may be performed for a length of time greater than about 1 hour.

### BRIEF DESCRIPTION OF THE DRAWINGS

FIG. 1 is a schematic representation and embodiment of the electrospinning apparatus of this invention including (A) a syringe pump, (B) a high voltage power supply, (C) a spinneret containing the electrospinning solution, (D) a stainless steel collector, (E) a digital hygrometer/thermometer, and (F) an acrylic electrospinning enclosure.

FIG. 2 shows SEM images of electrospun composite nanofibers using PVP solutions at (A) 9 wt %, (B) 10 wt %, and (C) 11 wt % mixed with 20 wt % SiO₂ NPs at a 2:3 ratio (20 wt % SiO₂ NPs:PVP solution). All other electrospinning parameters were held constant.

FIG. 3 is a chart showing the effect of the concentration of PVP on average composite nanofiber diameter. All other electrospinning parameters were held constant.

FIG. 4 shows SEM images of electrospun composite nanofibers using SiO₂ NP dispersions at (A) 20 wt %, (B) 25 wt %, and (C) 30 wt % mixed with 10 wt % PVP at a 2:3 ratio (SiO₂ NP dispersion:10 wt % PVP solution). All other electrospinning parameters were held constant.

FIG. 5 is a chart showing the effect of concentration of silica nanoparticles on average composite nanofiber diameter. All other electrospinning parameters were held constant.

FIG. 6 shows SEM images of electrospun composite nanofibers using ratios of 20 wt % SiO₂ NPs:10 wt % PVP of (A) 2:3, (B) 2.5:3, and (C) 3:3. All other electrospinning parameters were held constant.

FIG. 7 shows SEM images of electrospun composite nanofibers using applied voltage of (A) 8 kV, (B) 10 kV, and (C) 12 kV. All other electrospinning parameters were held constant.

FIG. 8 is a chart showing mat thickness as a function of electrospinning time for as-spun composite PVP/SiO₂ NP nanofibers. All other electrospinning parameters were held constant.

FIG. 9 shows (A) a digital image of as-spun composite nanofibers using optimized electrospinning parameters (2:3 ratio of 20 wt % SiO₂ NPs:10 wt % PVP, 30 min electrospinning time, 10 kV, 15 cm, 15 μL/min, ambient humidity) and SEM images of the electrospun nanofibers revealing (B) nanofiber morphology viewed from the top-down and (C) stationary phase thickness viewed from the mat edge.

FIG. 10 shows SEM images of post-processed electrospun nanofibers using final temperatures of (A) 350° C., (B) 400° C., (C) 450° C., (D) 465° C., (E) 475° C., and (F) 500° C. Ramp rate was 2° C./min and the final temperature was held for 2 h. Electrospinning parameters were held constant.

FIG. 11 shows digital images of post-processed electrospun nanofibers using final temperatures of (A) 450° C., (B) 465° C., and (C) 475° C. Ramp rate was 0.5° C./min and the final temperature was held for 6 h. Electrospinning parameters were held constant.\

FIG. 12 shows (A) a digital image of post-processed electrospun nanofibers using optimized post-processing conditions (465° C., 0.5° C./min, 6 h hold). Electrospinning parameters were held constant (2:3 ratio of 20 wt % SiO₂ NPs:10 wt % PVP, 2.5 h electrospinning time, 10 kV, 15 cm, 15 μL/min, ambient humidity). SEM images of post-processed electrospun nanofibers revealing (B) nanofiber morphology viewed from the top-down and (C) stationary phase thickness viewed from the mat edge.

FIG. 13 is a chart showing mat thickness of post-processed PVP/SiO₂ NP nanofibers at various stages. Electrospinning parameters (2:3 ratio of 20 wt % SiO₂ NPs:10 wt % PVP, 2.5 h, 10 kV, 15 cm, 15 μL/min, ambient humidity) and post-processing conditions (465° C., 0.5° C./min, 6 h) were held constant.

FIG. 14 is a chart showing average nanofiber diameter of post-processed PVP/SiO₂ NP nanofibers at various stages. Electrospinning parameters (2:3 ratio of 20 wt % SiO₂ NPs:10 wt % PVP, 2.5 h, 10 kV, 15 cm, 15 μL/min, ambient humidity) and post-processing conditions (465° C., 0.5° C./min, 6 h) were held constant.

### DETAILED DESCRIPTION

This disclosure is not limited in its application to the details of construction and the arrangement of components set forth in the following description. The disclosure may provide other embodiments and may be practiced or carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

It also is understood that any numerical range recited herein includes all values from the lower value to the upper value. For example, if a concentration range is stated as 1% to 50%, it is intended that values such as 2% to 40%, 10% to 30%, or 1% to 3%, etc., are expressly enumerated in this specification. These are only examples of what is specifically intended, and all possible combinations of numerical values between and including the lowest value and the highest value enumerated are to be considered to be expressly stated in this application.

It should be understood that, as used herein, the term “about” is synonymous with the term “approximately.” Illustratively, the use of the term “about” indicates that a value includes values slightly outside the cited values. Variation may be due to conditions such as experimental error, manufacturing tolerances, variations in equilibrium conditions, and the like. In some embodiments, the term “about” includes the cited value plus or minus 10%. In all cases, where the term “about” has been used to describe a value, it should be appreciated that this disclosure also supports the exact value.

To the extent that they complement the specification and are enabling of the disclosed embodiments, the following publications are each incorporated herein in their entirety by reference: The Doctoral Dissertation of Jeremy Steach entitled: The Development of Novel Phases with Photoresist for Capillary Electrophoresis, Capillary Electrochromatography, and Solid-Phase Microextraction, available at the Ohio State University; The Doctoroal Dissertation of Jonathan E. Clark entitled: Unique Applications of Nanomaterials in Separation Science, available at the Ohio State University; Master's Thesis of Joseph W. Zewe, Electrospun Fibers for Solid Phase Extraction, 2010; Newsome, Toni, E., Zewe, Joseph, W., Olesik, Susan V., “Electrospun nanofibrous solid-phase microextraction coatings for preconcentration of pharmaceuticals prior to liquid chromatographic separations Journal of Chromatography A 2012, 1262, 1-7; Lu, Tian; Olesik, Susan V., Polyvinyl alcohol ultra-thin layer chromatography of amino acids, Journal of Chromatography, B: 2013, 912, 98-104; and Beilke, Michael E., Zewe, Joseph W., Clark, Jonathan E., and Olesik, Susan V., “Aligned Electrospun Nanofibers for Ultra-thin Layer Chromatography,” Analytica Chimica Acta, (2013), 761, 201-208.

This disclosure provides ultrathin-layer chromatography plates and methods of making and using ultrathin-layer chromatography plates, as described in detail below.

### I. Ultrathin-Layer Chromatography Plates

This disclosure provides ultrathin-layer chromatography plates including a stationary phase comprising electrospun nanofibers, wherein the stationary phase has a thickness from about 10 μm to about 30 μm.

The UTLC plates disclosed herein may comprise a stationary phase having a thickness of at least about 10 μm, such as at least about 11 μm, at least about 12 μm, at least about 13 μm, at least about 14 μm, at least about 15 μm, at least about 16 μm, at least about 17 μm, at least about 18 μm, at least about 19 μm, at least about 20 μm, at least about 21 μm, at least about 22 μm, at least about 23 μm, at least about 24 μm, at least about 25 μm, at least about 26 μm, at least about 27 μm, at least about 28 μm, or at least about 29 μm. The UTLC plates disclosed herein may comprise a stationary phase having a thickness of at most about 30 μm, such as at most about 29 μm, at most about 28 μm, at most about 27 μm, at most about 26 μm, at most about 25 μm, at most about 24 μm, at most about 23 μm, at most about 22 μm, at most about 21 μm, at most about 20 μm, at most about 19 μm, at most about 18 μm, at most about 17 μm, at most about 16 μm, at most about 15 μm, at most about 14 μm, at most about 13 μm, at most about 12 μm, or at most about 11 μm. This includes embodiments where the stationary phase thickness ranges from about 10 μm to about 30 μm, including, but not limited to, ranges from about 12.5 μm to about 27.5 μm, and from about 15 μm to about 25 μm.

The UTLC plate disclosed herein may comprise a stationary phase having a length and a width. In some embodiments, the UTLC plate may comprise a stationary phase having a thickness that is substantially consistent along its entire length and width.

Electrospun Nanofibers

The ultrathin-layer chromatography plates disclosed herein may comprise a stationary phase including electrospun nanofibers comprising silica.

The UTLC plates disclosed herein may comprise a stationary phase including electrospun nanofibers comprising at least about 50 wt % silica, such as at least about 60 wt % silica, at least about 70 wt % silica, at least about 80 wt % silica, at least about 90 wt % silica, at least about 91 wt % silica, at least about 92 wt % silica, at least about 93 wt % silica, at least about 94 wt % silica, at least about 95 wt % silica, at least about 96 wt % silica, at least about 97 wt % silica, at least about 98 wt % silica, at least about 99 wt % silica, or at least about 99.5 wt % silica. In some embodiments, the UTLC plates disclosed herein may comprise a stationary phase including electrospun nanofibers comprising at most about 99.9 wt % silica, such as at most about 99.5 wt %, at most about 99 wt %, at most about 98 wt %, at most about 97 wt %, at most about 96 wt %, at most about 95 wt %, at most about 94 wt %, at most about 93 wt %, at most about 92 wt %, or at most about 91 wt %. This includes embodiments where the stationary phase includes silica in amounts ranging from about 50 wt % to about 99.9 wt %, including, but not limited to, amounts ranging from about 60 wt % to about 99 wt %, and from about 90 wt % to about 95 wt %.

In some embodiments, the electrospun nanofibers may further comprise polyvinylpyrrolidone. In some embodiments, the electrospun nanofibers may comprise at least about 0.1% polyvinylpyrrolidone, such as at least about 0.5%, at least about 1%, at least about 2%, at least about 3%, at least about 4%, at least about 5%, at least about 6%, at least about 7%, at least about 8%, or at least about 9% polyvinylpyrrolidone. In some embodiments, the electrospun nanofibers may comprise at most about 20% polyvinylpyrrolidone, such as at most about 15%, at most about 12%, at most about 10%, at most about 9%, at most about 8%, at most about 7%, at most about 6%, at most about 5%, at most about 4%, at most about 3%, at most about 2%, or at most about 1% polyvinylpyrrolidone.

The UTLC plates disclosed herein may include a stationary phase comprising electrospun nanofibers having an average diameter of at least about 200 nm, such as at least about 225 nm, at least about 250 nm, at least about 275 nm, at least about 300 nm, at least about 310 nm, at least about 320 nm, at least about 330 nm, at least about 340 nm, at least about 350 nm, at least about 360 nm, at least about 370 nm, at least about 380 nm, at least about 390 nm, at least about 400 nm, at least about 410 nm, at least about 420 nm, at least about 430 nm, at least about 440 nm, at least about 450 nm, at least about 460 nm, at least about 470 nm, at least about 480 nm, at least about 490 nm, at least about 500 nm, at least about 510 nm, at least about 520 nm, at least about 530 nm, at least about 540 nm, at least about 550 nm, at least about 560 nm, at least about 570 nm, at least about 580 nm, at least about 590 nm, at least about 600 nm, at least about 625 nm, at least about 650 nm, at least about 675 nm, at least about 700 nm, at least about 750 nm, at least about 800 nm, at least about 850 nm, at least about 900 nm, at least about 950 nm, at least about 1000 nm, at least about 1.25 μm, at least about 1.5 μm, or at least about 1.75 μm. The UTLC plates disclosed herein may include a stationary phase comprising electrospun nanofibers having an average diameter of at most about 2 μm, at most about 1.75 μm, at most about 1.5 μm, at most about 1.25 μm, at most about 1000 nm, at most about 900 nm, at most about 800 nm, at most about 700 nm, at most about 600 nm, at most about 590 nm, at most about 580 nm, at most about 570 nm, at most about 560 nm, at most about 550 nm, at most about 540 nm, at most about 530 nm, at most about 520 nm, at most about 510 nm, at most about 500 nm, at most about 490 nm, at most about 480 nm, at most about 470 nm, at most about 460 nm, at most about 450 nm, at most about 440 nm, at most about 430 nm, at most about 420 nm, at most about 410 nm, at most about 400 nm, at most about 390 nm, at most about 380 nm, at most about 370 nm, at most about 360 nm, at most about 350 nm, at most about 340 nm, at most about 330 nm, at most about 320 nm, at most about 310 nm, at most about 300 nm, at most about 275 nm, at most about 250 nm, at most about 225 nm, or at most about 200 nm. This includes embodiments where the electrospun nanofibers have an average diameter ranging from about 200 nm to about 2 μm, including, but not limited to, an average diameter ranging from about 250 nm to about 750 nm, and from about 300 nm to about 500 nm.

### II. Methods of Making Ultrathin-Layer Chromatography Plates

This disclosure provides methods of making an ultrathin-layer chromatography plate having a stationary phase comprising nanofibers comprising silica. In some embodiments, the method may comprise electrospinning a solution comprising polyvinylpyrrolidone and silica nanoparticles to form a mat comprising polyvinylpyrrolidone-silica composite nanofibers. In some embodiments, the method may further comprise heat treating the mat to form the stationary phase.

Electrospinning Target

In principle, the electrospinning target can be any target suitable for receiving the electrospun nanofibers of this disclosure. In principle, the electrospinning target may comprise any electrically conductive material or combination thereof.

In some embodiments, the electrospinning target may be of any suitable shape and size. In preferred embodiments, the electrospinning target may be substantially rectangular in shape.

In some embodiments, the electrospinning target may comprise a material selected from the group consisting of aluminum, steel, silicon, conductive glass plate, and combinations thereof.

In some embodiments, the electrospinning target may comprise a material selected from the group consisting of aluminum, steel, silicon, conductive glass plate, and combinations thereof.

Electrospinning Fibers

As used herein, the term electrospinning refers generally to placing a high electric field between a polymer or polymer-composite solution and a conductive collector. This collector may be comprised of many different materials such as metals, conductive polymers or the like, and may take the form of a plate, a film, a filament, a rod etc. When an electric field strong enough to overcome the surface tension of the droplet is provided, a Taylor cone is formed. Following the creation of the Taylor cone, fibers are ejected toward the conductive collector. With this technique, many different polymers and polymer blends can be used to generate and spin fibers with various chemical compositions and to fabricate mats comprising the fibers without the aid of binders.

In some embodiments, the methods may comprise electrospinning a solution comprising polyvinylpyrrlidone and silica nanoparticles to form a mat comprising polyvinylpyrrolidone-silica composite nanofibers.

In some embodiments, the electrospinning step may be performed at an applied voltage of at least about 1 kV, such as at least about 2 kV, at least about 3 kV, at least about 4 kV, at least about 5 kV, at least about 6 kV, at least about 7 kV, at least about 8 kV, at least about 9 kV, at least about 10 kV, at least about 11 kV, at least about 12 kV, at least about 13 kV, at least about 14 kV, at least about 15 kV, at least about 16 kV, at least about 17 kV, at least about 18 kV, at least about 19 kV, at least about 20 kV, at least about 21 kV, at least about 22 kV, at least about 23 kV, at least about 24 kV, at least about 25 kV, at least about 26 kV, at least about 27 kV, at least about 28 kV, at least about 29 kV, at least about 30 kV, or at least about 40 kV. In some embodiments, the electrospinning step may be performed at an applied voltage of at most about 50 kV, such as at most about 40 kV, at most about 35 kV, at most about 30 kV, at most about 29 kV, at most about 28 kV, at most about 27 kV, at most about 26 kV, at most about 25 kV, at most about 24 kV, at most about 23 kV, at most about 22 kV, at most about 21 kV, at most about 20 kV, at most about 19 kV, at most about 18 kV, at most about 17 kV, at most about 16 kV, at most about 15 kV, at most about 14 kV, at most about 13 kV, at most about 12 kV, at most about 11 kV, at most about 10 kV, or at most about 5 kV. This includes embodiments wherein the electrospinning step is performed at applied voltages ranging from about 1 kV to about 50 kV, including, but not limited to applied voltages ranging from 10 kV to about 30 kV, and from about 15 kV to about 25 kV.

In some embodiments, the electrospinning step may be performed at a flow rate of at least about 1 μL/min, such as at least about 5 μL/min, at least about 10 μL/min, at least about 11 μL/min, at least about 12 μL/min, at least about 13 μL/min, at least about 14 μL/min, at least about 15 μL/min, at least about 16 μL/min, at least about 17 μL/min, at least about 18 μL/min, at least about 19 μL/min, at least about 20 μL/min, at least about 21 μL/min, at least about 22 μL/min, at least about 23 μL/min, at least about 24 μL/min, at least about 25 μL/min, at least about 26 μL/min, at least about 27 μL/min, at least about 28 μL/min, at least about 29 μL/min, at least about 30 μL/min, at least about 35 μL/min, at least about 40 μL/min, at least about 45 μL/min, at least about 50 μL/min, at least about 60 μL/min, at least about 70 μL/min, at least about 80 μL/min, or at least about 90 μL/min. In some embodiments, the electrospinning step may be performed at a flow rate of at most about 100 μL/min, such as at most about 90 μL/min, at most about 80 μL/min, at most about 75 μL/min, at most about 70 μL/min, at most about 65 μL/min, at most about 60 μL/min, at most about 55 μL/min, at most about 50 μL/min, at most about 45 μL/min, at most about 40 μL/min, at most about 35 μL/min, at most about 30 μL/min, at most about 29 μL/min, at most about 28 μL/min, at most about 27 μL/min, at most about 26 μL/min, at most about 25 μL/min, at most about 24 μL/min, at most about 23 μL/min, at most about 22 μL/min, at most about 21 μL/min, at most about 20 μL/min, at most about 19 μL/min, at most about 18 μL/min, at most about 17 μL/min, at most about 16 μL/min, at most about 15 μL/min, at most about 14 μL/min, at most about 13 μL/min, at most about 12 μL/min, at most about 11 μL/min, at most about 10 μL/min, at most about 5 μL/min, or at most about 2 μL/min. This include embodiments wherein the electrospinning step is performed at flow rates ranging from about 1 μL/min to about 100 μL/min, including, but not limited to, flow rates ranging from about 5 μL/min to about 50 μL/min, and from about 10 μL/min to about 30 μL/min.

In some embodiments, the electrospinning step may be performed with a distance from the electrospinning tip to target of at least about 1 cm, such as at least about 2 cm, at least about 3 cm, at least about 4 cm, at least about 5 cm, at least about 6 cm, at least about 7 cm, at least about 8 cm, at least about 9 cm, at least about 10 cm, at least about 11 cm, at least about 12 cm, at least about 13 cm, at least about 14 cm, at least about 15 cm, at least about 16 cm, at least about 17 cm, at least about 18 cm, at least about 19 cm, at least about 20 cm, at least about 21 cm, at least about 22 cm, at least about 23 cm, at least about 24 cm, at least about 25 cm, at least about 26 cm, at least about 27 cm, at least about 28 cm, at least about 29 cm, at least about 30 cm, at least about 35 cm, at least about 40 cm, or at least about 45 cm. In some embodiments, the electrospinning step may be performed with a distance from the electrospinning tip to target of at most about 50 cm, such as at most about 45 cm, at most about 40 cm, at most about 35 cm, at most about 34 cm, at most about 33 cm, at most about 32 cm, at most about 31 cm, at most about 30 cm, at most about 29 cm, at most about 28 cm, at most about 27 cm, at most about 26 cm, at most about 25 cm, at most about 24 cm, at most about 23 cm, at most about 22 cm, at most about 21 cm, at most about 20 cm, at most about 19 cm, at most about 18 cm, at most about 17 cm, at most about 16 cm, at most about 15 cm, at most about 14 cm, at most about 13 cm, at most about 12 cm, at most about 11 cm, at most about 10 cm, at most about 5 cm, or at most about 2 cm. This includes embodiments wherein the electrospinning step is performed with a distance from the electrospinning tip to target ranging from about 1 cm to about 50 cm, including, but not limited to, distances ranging from about 5 cm to about 30 cm, and distances ranging from about 10 cm to about 20 cm.

In some embodiments, the electrospinning step may be performed for a length of time at least about 5 minutes, such as at least about 10 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 1 hour, at least about 2 hours, at least about 3 hours, at least about 4 hours, at least about 8 hours, or at least about 12 hours. In some embodiments, the electrospinning step may be performed for a length of time at most about 24 hours, such as at most about 12 hours, at most about 8 hours, at most about 7 hours, at most about 6 hours, at most about 5 hours, at most about 4 hours, at most about 3 hours, at most about 2 hours, at most about 1 hour, at most about 50 minutes, at most about 40 minutes, or at most about 30 minutes. This includes embodiments wherein the electrospinning step is performed for lengths of time ranging from about 5 minutes to about 8 hours, including, but not limited to, lengths of time ranging from about 10 minutes to about 4 hours, and ranging from about 30 minutes to about 3 hours.

Electrospinning Solutions

In some embodiments, the solution may comprise at least about 1 wt % polyvinylpyrrolidone, such as at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, at least about 20 wt %, at least about 21 wt %, at least about 22 wt %, at least about 23 wt %, at least about 24 wt %, at least about 25 wt % polyvinylpyrrolidone. In some embodiments, the solution may comprise at most about 50 wt % polyvinylpyrrolidone, such as at most about 45 wt %, at most about 40 wt %, at most about 35 wt %, at most about 30 wt %, at most about 29 wt %, at most about 28 wt %, at most about 27 wt %, at most about 26 wt %, at most about 25 wt %, at most about 24 wt %, at most about 23 wt %, at most about 22 wt %, at most about 21 wt %, at most about 20 wt %, at most about 19 wt %, at most about 18 wt %, at most about 17 wt %, at most about 16 wt %, at most about 15 wt %, at most about 14 wt %, at most about 13 wt %, at most about 12 wt %, at most about 11, or at most about 10 wt % polyvinylpyrrolidone. This includes embodiments wherein the solution comprises from about 1 wt % to about 50 wt % polyvinylpyrrolidone, including, but not limited to, from about 5 wt % to about 25 wt % polyvinylpyrrolidone, and from about 7.5 wt % to about 15 wt % polyvinylpyrrolidone.

In some embodiments, the solution may comprise at least about 1 wt % silica nanoparticles, such as at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, at least about 11 wt %, at least about 12 wt %, at least about 13 wt %, at least about 14 wt %, at least about 15 wt %, at least about 16 wt %, at least about 17 wt %, at least about 18 wt %, at least about 19 wt %, or at least about 20 wt % silica nanoparticles. In some embodiments, the solution may comprise at most about 25 wt % silica nanoparticles, such as at most about 24 wt %, at most about 23 wt %, at most about 22 wt %, at most about 21 wt %, at most about 20 wt %, at most about 19 wt %, at most about 18 wt %, at most about 17 wt %, at most about 16 wt %, at most about 15 wt %, at most about 14 wt %, at most about 13 wt %, at most about 12 wt %, at most about 11, or at most about 10 wt % silica nanoparticles. This includes embodiments wherein the solution comprises from about 1 wt % to about 15 wt % silica nanoparticles, including, but not limited to, from about 2 wt % to about 10 wt % silica nanoparticles, and from about 3 wt % to about 7 wt % silica nanoparticles.

In general, the electrospinning solutions can comprise any solvent suitable for use in electrospinning.

Heat Treating

The methods described herein may comprise heat treating a mat comprising polyvinlypyrrolidone-silica composite nanofibers to form a stationary phase including nanofibers comprising at least about 90% silica.

In some embodiments, the heat treating step may be performed at a temperature of at least about 100° C., such as at least about 110° C., at least about 120° C., at least about 130° C., at least about 140° C., at least about 150° C., at least about 160° C., at least about 170° C., at least about 180° C., at least about 190° C., at least about 200° C., at least about 225° C., at least about 250° C., at least about 275° C., at least about 300° C., at least about 325° C., at least about 350° C., at least about 375° C., at least about 400° C., at least about 410° C., at least about 420° C., at least about 430° C., at least about 440° C., at least about 450° C., at least about 455° C., at least about 460° C., at least about 465° C., or at least about 470° C. In some embodiments, the heat treating step may be performed at a temperature of at most about 475° C., such as at most about 470° C., at most about 465° C., at most about 460° C., at most about 455° C., at most about 450° C., at most about 425° C., at most about 400° C., at most about 375° C., at most about 350° C., at most about 325° C., at most about 300° C., at most about 290° C., at most about 280° C., at most about 270° C., at most about 260° C., at most about 250° C., at most about 240° C., at most about 230° C., at most about 220° C., at most about 210° C., at most about 200° C., at most about 190° C., at most about 180° C., at most about 170° C., at most about 160° C., at most about 150° C., at most about 140° C., at most about 130° C., at most about 120° C., or at most about 110° C. This includes embodiments wherein the heat treating step is performed at temperatures ranging from about 100° C. to about 475° C., including but not limited to, temperatures ranging from about 100° C. to about 200° C., and from about 455° C. to about 470° C.

In some embodiments, the heat treating step is performed for a length of time of greater than about 1 hour, such as greater than about 2 hours, greater than about 3 hours, greater than about 4 hours, greater than about 5 hours, greater than about 6 hours, greater than about 7 hours, greater than about 8 hours, greater than about 12 hours, or greater than about 18 hours. In some embodiments, the heat treating step is performed for a length of time of less than about 24 hours, such as less than about 20 hours, less than about 18 hours, less than about 16 hours, less than about 14 hours, less than about 12 hours, less than about 11 hours, less than about 10 hours, less than about 9 hours, less than about 8 hours, less than about 7 hours, less than about 6 hours, less than about 5 hours, less than about 4 hours, less than about 3 hours, or less than about 2 hours. This includes embodiments wherein the heat treating step is performed for lengths of time ranging from about 1 hour to about 24 hours, such as lengths of time ranging from about 1.5 hours to about 12 hours, and from about 2 hours to about 8 hours.

In some embodiments, the heat treating step may be preceded by raising the temperature of the mat at a ramp rate until the temperature of heat treating is reached. In some embodiments, the temperature is raised slowly. In some embodiments, the ramp rate is at least about 0.05° C./min, such as at least about 0.1° C./min, at least about 0.2° C./min, at least about 0.3° C./min, at least about 0.4° C./min, at least about 0.5° C./min, at least about 0.6° C./min, at least about 0.7° C./min, at least about 0.8° C./min, at least about 0.9° C./min, at least about 1.0° C./min, at least about 1.5° C./min, at least about 2.0° C./min, at least about 2.5° C./min, at least about 3.0° C./min, at least about 3.5° C./min, at least about 4.0° C./min, at least about 4.5° C./min, or at least about 5.0° C./min. In some embodiments, the ramp rate is at most about 5.0° C./min, such as at most about 4.5° C./min, at most about 4.0° C./min, at most about 3.5° C./min, at most about 3.0° C./min, at most about 2.9° C./min, at most about 2.8° C./min, at most about 2.7° C./min, at most about 2.6° C./min, at most about 2.5° C./min, at most about 2.4° C./min, at most about 2.3° C./min, at most about 2.2° C./min, at most about 2.1° C./min, at most about 2.0° C./min, at most about 1.9° C./min, at most about 1.8° C./min, at most about 1.7° C./min, at most about 1.6° C./min, at most about 1.5° C./min, at most about 1.4° C./min, at most about 1.3° C./min, at most about 1.2° C./min, at most about 1.1° C./min, at most about 1.0° C./min, at most about 0.9° C./min, at most about 0.8° C./min, at most about 0.7° C./min, at most about 0.6° C./min, at most about 0.5° C./min, at most about 0.4° C./min, at most about 0.3° C./min, at most about 0.2° C./min, or at most about 0.1° C./min.

In some embodiments, heat treating causes the stationary phase to detach from the target. In these embodiments, the stationary phase may be mounted to a suitable substrate to form the UTLC plate. In some embodiments, the stationary phase may be mounted using methanol to wet the stationary phase and allow adhesion to the substrate.

In certain embodiments, no heat treating step is performed, and the mat comprising composite nanofibers serves as the stationary phase for the UTLC plate. In these embodiments, the method comprises electrospinning a solution comprising polyvinylpyrrolidone and silica nanoparticles to form a mat comprising polyvinylpyrrolidone-silica composite nanofibers, the mat having a thickness ranging from about 10 μm to about 30 μm.

### EXAMPLES

Exemplary embodiments of the present invention are provided in the following examples. The following examples are presented to illustrate the present invention and to assist one of ordinary skill in making and using the same. The examples are not intended in any way to otherwise limit the scope of the invention.

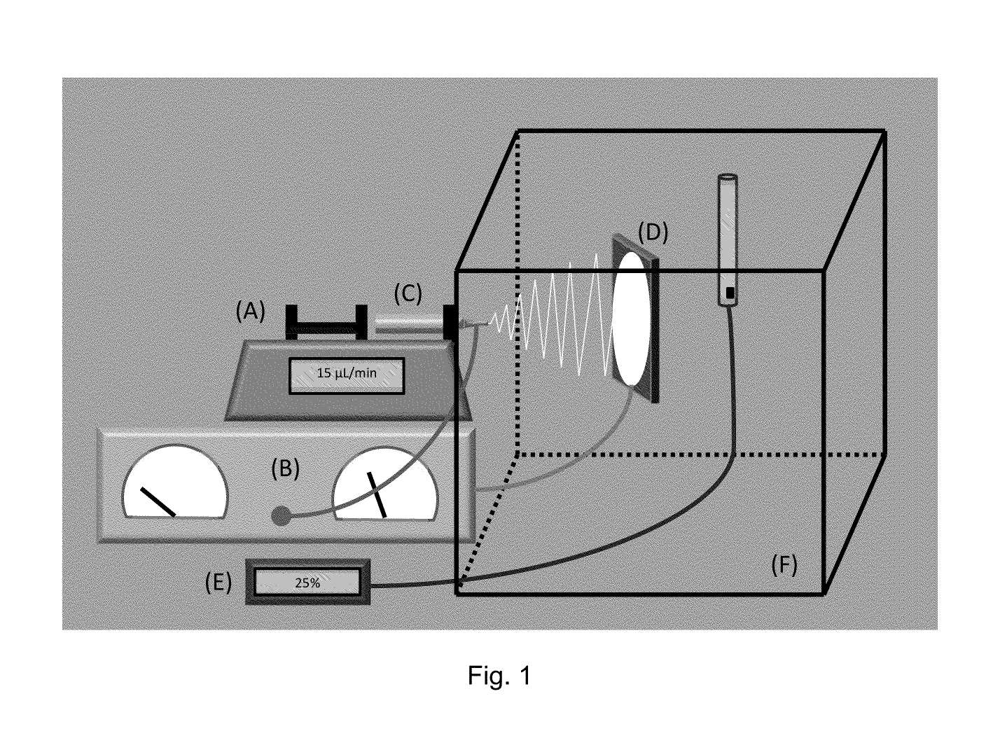

The electrospinning apparatus used in this experiment to produce composite PVP/SiO₂ NP nanofibers is depicted in FIG. 1. Electrospinning solutions are prepared as described herein. A Spellman CZE 1000R high voltage power supply was used to supply voltages from 5 to 15 kV. A Harvard Model 33 dual syringe pump was used to control the flow rate of the electrospinning solutions. The flow rates were varied from 0 to 2 mL/min. Electrospinning experiments were performed while varying the following parameters: electrospinning solution concentrations, voltage, flow rate, and distance from the electrospinning tip to the target to determine the optimum parameters for production of fibers.

The nanofibers were collected onto an electrospinning target consisting of a 0.003″ thick stainless steel (SS316) shim stock with a 6.5 cm×11.0 cm area.

UTLC plates were prepared from as-spun composite PVP/SiO₂ NP nanofibrous mats by cutting the original 6.5 cm×11.0 cm mat on shim stock into three 3.0 cm×6.5 cm plates. Because post-processed samples detached from the original shim stock during heat treatments, UTLC plates were prepared from the post-processed samples by first re-adhering the mat to a clean piece of 6.5 cm×11.0 cm stainless steel shim stock using methanol; the re-adhered post-processed mats were then washed with methanol, allowed to dry overnight, and cut to an appropriate size for UTLC separations (˜2×5 cm).

Analytes were spotted onto the bottom of the UTLC plates using a NanoJet syringe pump (Chemyx, Stafford, Tex.) equipped with a Model 62 Hamilton syringe (0.343 mm I.D., Reno, Nev.); the volume of analyte spotted was ˜50 mL. A cylindrical glass jar (volume=250 mL) topped with a watchglass served as the development chamber. All experiments used 5 mL of mobile phase with a 10 minute equilibration time prior to development. The development of laser dyes on the as-spun composite nanofibrous plates was carried out using a 10/90 or 20/80 (v/v) ethyl acetate:heptane mobile phase. All as-spun composite plates were developed using a migration distance of 3.5 cm. The development of laser dyes on the post-processed nanofibrous plates was carried out using a 10:90, 20:80, or 30:70 (v/v) ethyl acetate:heptane mobile phase. All post-processed plates were developed using a migration distance of 1.0 cm, 1.5 cm, or 2.0 cm.

Following development, analysis was conducted utilizing a digital documentation system (Spectroline, Westbury, N.Y.). The system consists of a CC-81 cabinet fitted with an ENF-280C 365 nm/254 nm, 8 W UV lamp and a GL-1301 universal camera adapter with a 58 mm adapter ring. The camera that was utilized was a Canon A650IS 12.1 MP digital camera. Digital photographs were subsequently analyzed with ImageJ as well as TLC Analyzer (available at http://www.sciencebuddies.org/science-research-papers/tlc analyzer.shtml) (see, A. V. I. Hess, J. Chem. Educ. 84 (2007) 842-847, which is incorporated herein in its entirety by reference) and PeakFit. All images were darkened to enhance contrast prior to analysis. Analytes were visualized via exposure to UV radiation at λ=254 nm.

The silica nanoparticles (SiO₂ NPs), AngstromSphere monodispersed silica powder, 250 nm, were purchased from Fiber Optic Center Inc. (New Bedford, Mass.). The electrospinning polymer, polyvinylpyrrolidone (PVP), average M_{w} 1,300,000, K 85-95, was purchased from Acros Organics through Fisher Scientific (Pittsburgh, Pa.). Reagent alcohol (HPLC grade), the solvent for the polymer solution and nanoparticle dispersion, was purchased from Fisher Scientific.

The laser dyes were purchased from Exciton Inc. (Dayton, Ohio); the dyes included rhodamine 610 chloride, rhodamine 610 perchlorate, and pyrromethene 597. Ethyl acetate and methanol were purchased from Macron Chemicals (St. Louis, Mo.). Heptane was purchased from Fisher Scientific.

The scanning electron microscopes (SEM) used to obtain images of the electrospun nanofibers included a Hitachi S-3400 SEM (Hitachi High Technologies America, Inc., Pleasonton, Calif.) and a Quanta 200 Series SEM (FEI Company, Hillsboro, Oreg.). For the Hitachi S-3400 SEM, each sample was sputter coated with gold for 2 min at 10 μA to create a conductive surface for SEM imaging. Similarly, for the Quanta SEM, each sample was sputter coated with gold for 1 min at 15 μA. The as-spun composite PVP/SiO₂ NP nanofibers were post-processed using a Lindberg/Blue M tube furnace (Waltham, Mass.).

The electrospinning solutions were prepared by the following procedure. Polyvinylpyrrolidone was dissolved in reagent alcohol (9-11 wt %) at room temperature. Silica nanoparticles (250 nm diameter) with a particle size standard deviation of <10% were dispersed in reagent alcohol (20-30 wt %). The dispersions were stirred for 1 h, sonicated for 3 h, and stirred overnight (≧12 h). These dispersions were re-sonicated for at least 30 minutes prior to making the composite electrospinning solutions. The electrospinning solutions were prepared by mixing the SiO₂ NP dispersion with the PVP solution at a given weight ratio. The electrospinning solution was vigorously stirred for 1 h and sonicated for at least 3 h prior to electrospinning.

### Example 1

### Polyvinylpyrrolidone Concentration

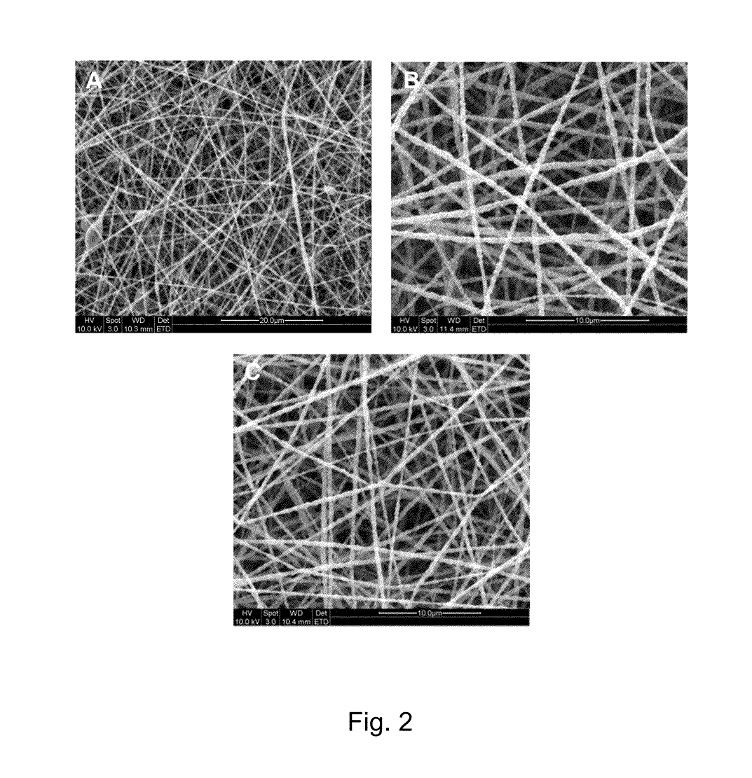

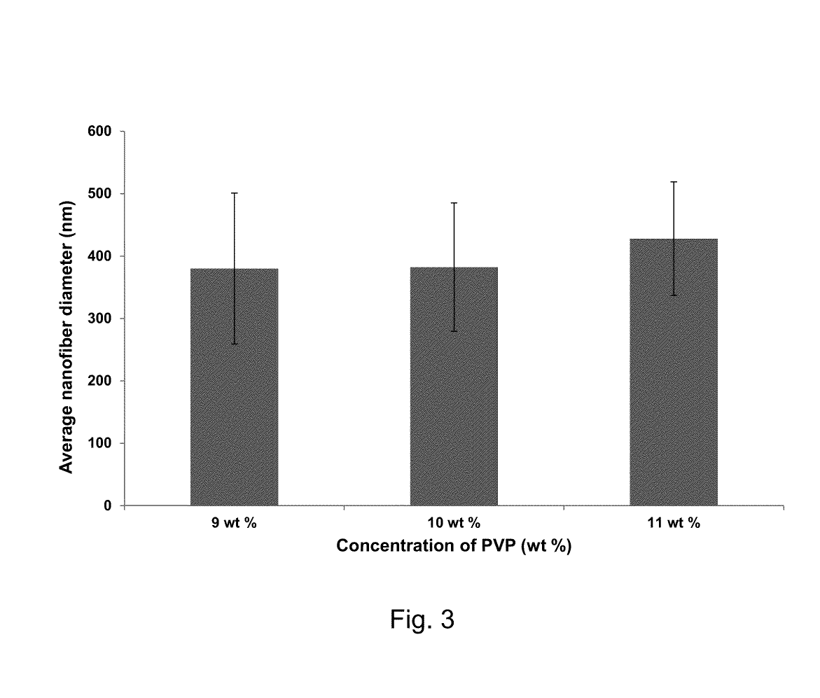

To investigate the effect of polyvinylpyrrolidone concentration on the electrospun composite nanofibers, PVP solutions at 9, 10, and 11 wt % PVP in reagent alcohol were mixed with 20 wt % SiO₂ NPs in reagent alcohol at a 2:3 ratio (20 wt % SiO₂ NPs:PVP solution). FIG. 2 shows SEM images of the resulting composite nanofibers. The nanofibers from the 9 wt % PVP solution contain morphological deformities such as beads under these particular electrospinning conditions. This mixed morphology is not desirable within a chromatographic stationary phase. The nanofibers from both the 10 and 11 wt % PVP solution do not contain beads; however, FIG. 3 demonstrates that the nanofibers resulting from the 10 wt % PVP solution have a smaller average nanofiber diameter than those resulting from the 11 wt % solution (380±100 nm compared to 430±90 nm, respectively).

### Example 2

### Nanoparticle Concentration

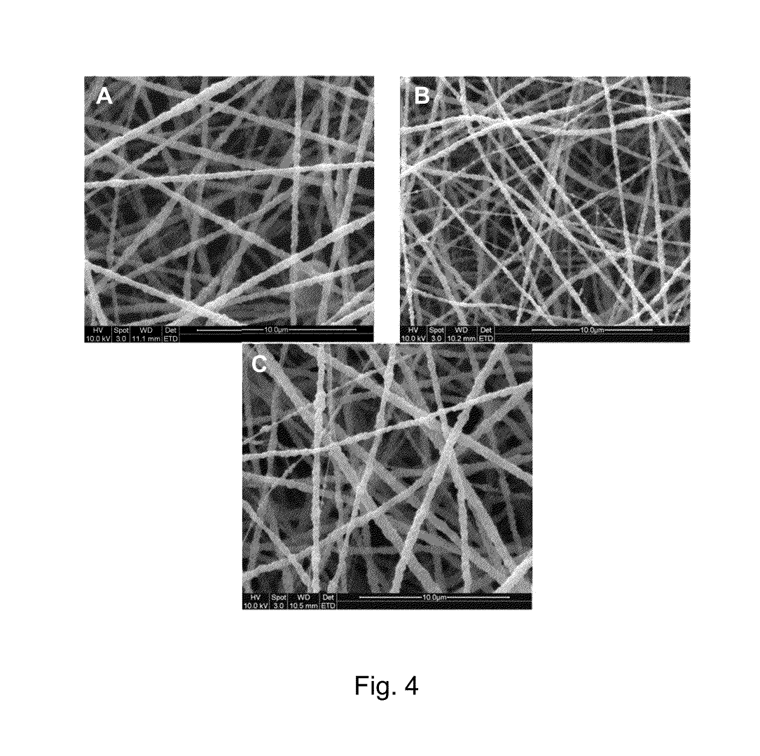

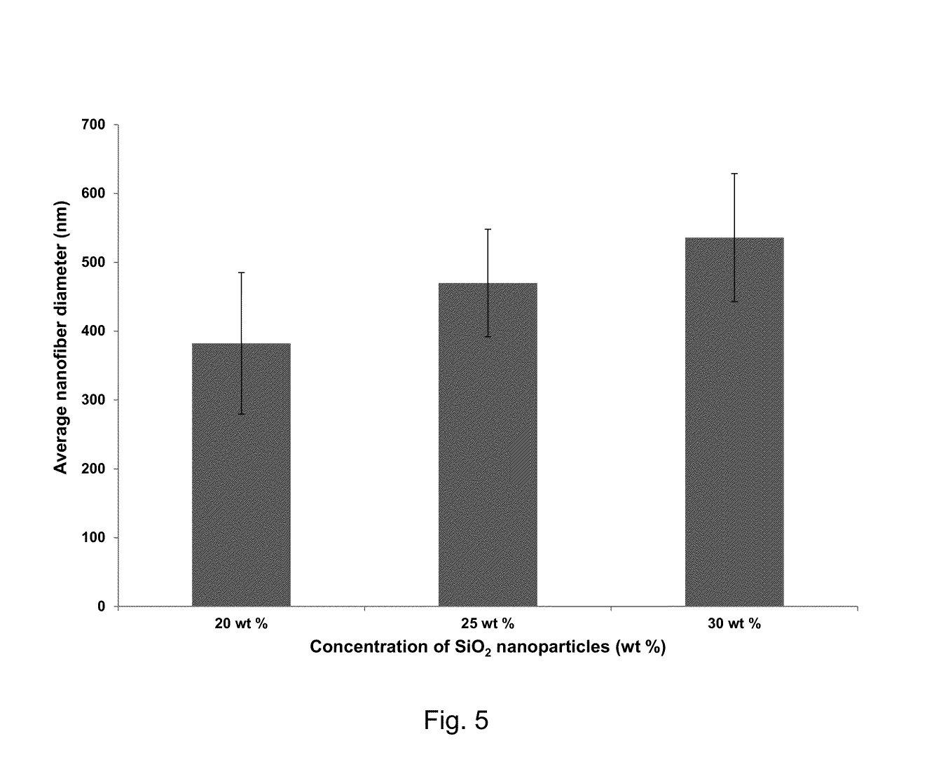

To investigate the effect of nanoparticle concentration on the electrospun composite nanofibers, SiO₂ NP dispersions at 20, 25, and 30 wt % SiO₂ NPs in reagent alcohol were mixed with 10 wt % PVP in reagent alcohol at a 2:3 ratio (SiO₂ NP dispersion:10 wt % PVP). Under these particular electrospinning conditions, increasing the SiO₂ NP concentration from 20 to 25 wt % yielded more heterogeneous nanofibers in that there were an increasing number of nanofibers with large distances between nanoparticles (FIGS. 4A and 4B, respectively). This was not an issue with the nanofibers from the 20 or 30 wt % SiO₂ NP dispersion; however, FIG. 5 demonstrates that the nanofibers resulting from the 20 wt % SiO₂ NP dispersion have a smaller average nanofiber diameter than those resulting from the 30 wt % SiO₂ NP dispersion (380±100 nm compared to 540±90 nm, respectively).

### Example 3

### Ratio of Nanoparticles to Polymer

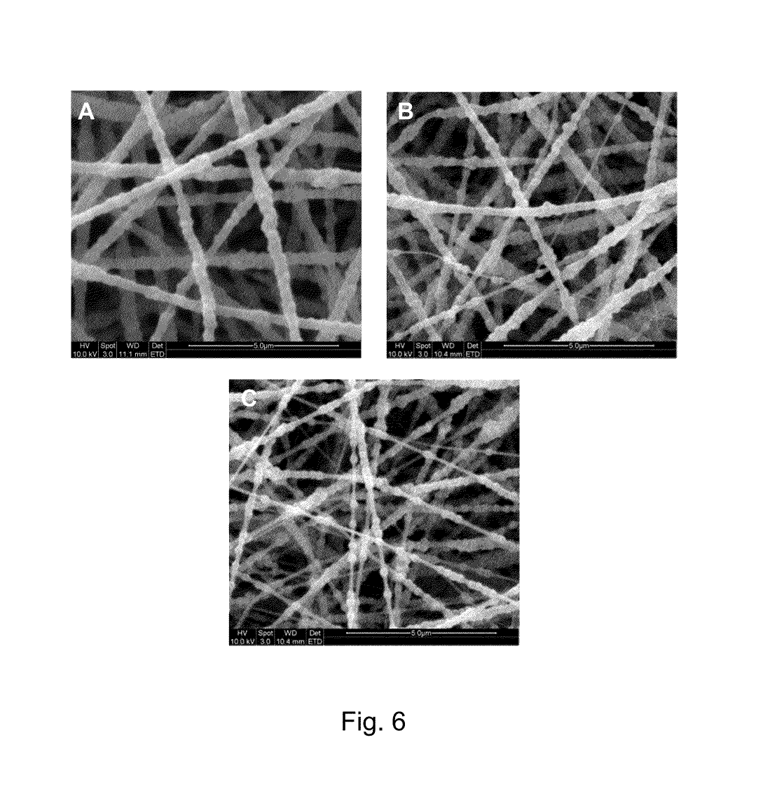

To investigate the effect of varying the ratio at which the SiO₂ NP dispersion and PVP solution was mixed, ratios of 2:3, 2.5:3, and 3:3 (20 wt % SiO₂ NPs:10 wt % PVP) were examined. The resulting average nanofiber diameters are reported in FIG. 5. FIG. 6 shows that an increasing the ratio of SiO₂ NP dispersion to the PVP solution under these particular electrospinning conditions produced nanofibers which were increasingly heterogeneous (an increasing number of beaded nanofibers and nanofibers with large distances between nanoparticles).

### Example 4

### Other Electrospinning Parameters

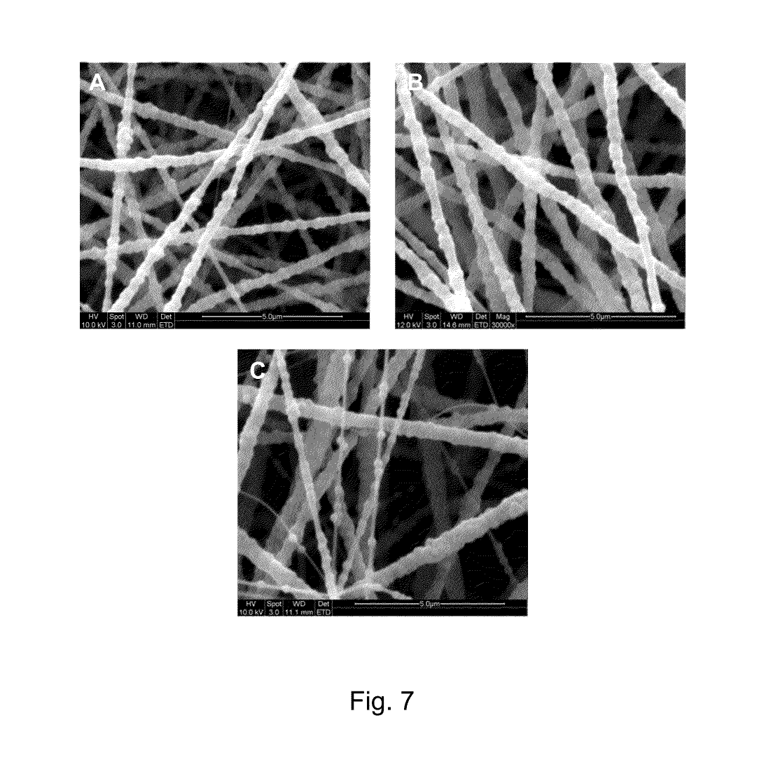

Other controllable parameters were varied and include flow rate, relative humidity, tip to collector distance, and applied voltage. The flow rate was varied from 15 to 30 μL/min and had no noticeable effect on the morphology or average nanofiber diameter. To maximize the amount of time an electrospinning solution can be used, 15 μL/min was used. Similarly, the relative humidity was varied from 10% to 55% and had no noticeable effect on morphology or average nanofiber diameter. The tip to collector distance also had no noticeable effect on the average nanofiber diameter or morphology at the nanoscale. However, under these particular electrospinning parameters, using a distance of 10 cm produced mats that were only about 4 cm×4 cm in size (˜1 UTLC plate) as compared to those produced at 15 cm which covered the entire collector (6.5 cm×11.0 cm; 3 UTLC plates); using a distance of 20 cm produced mats that were visibly thinner than those produced at 15 cm with the same given collection time. The applied voltage had a dramatic effect on nanofiber morphology. FIG. 7 demonstrates that the nanoparticles are more homogenous within the nanofibers spun at 10 kV (FIG. 7B) than those spun at 8 kV and 12 kV (FIGS. 7A and 7C, respectively).

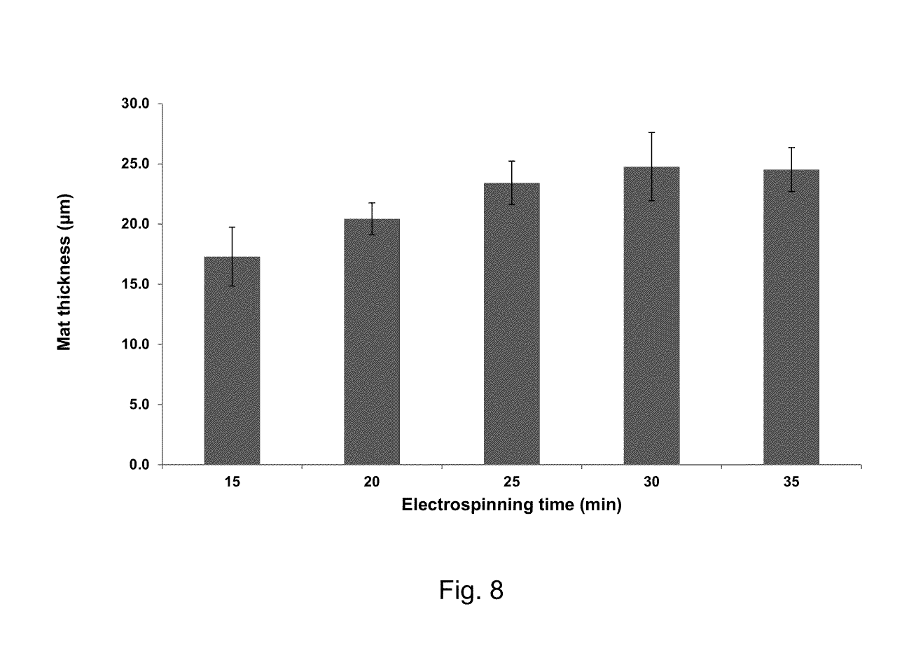

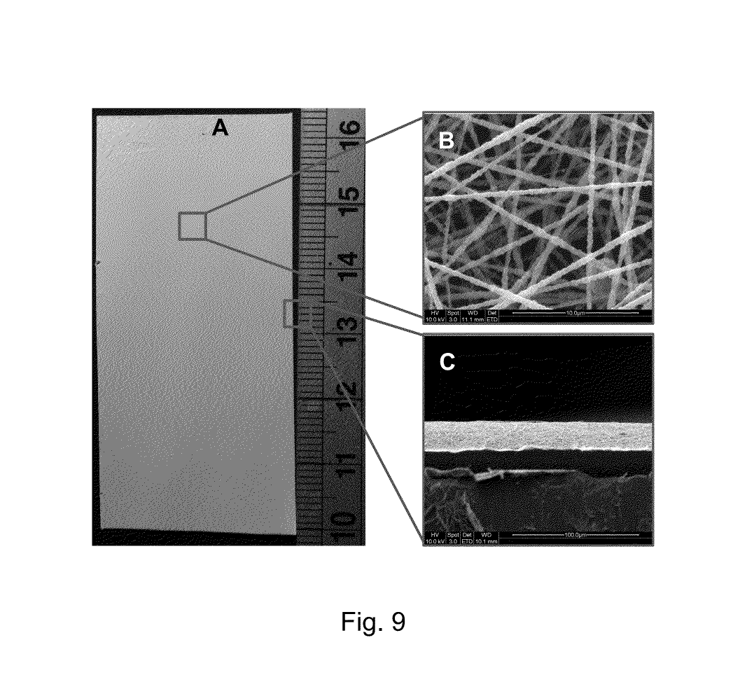

Finally, the effect of total electrospinning time on mat thickness was determined for the composite nanofibers using the aforementioned electrospinning parameters. As-spun composite nanofibrous mats were produced at collection times of 15, 20, 25, 30, and 35 minutes. As demonstrated in FIG. 8, mat thickness increases linearly with electrospinning time between 15 and 30 minutes; this relationship begins to deviate from linearity at 35 minutes. To maximize mat thickness and minimize collection time, 30 minutes was chosen as the optimum electrospinning time for the as-spun composite nanofibrous stationary phases. Using optimized electrospinning parameters, the as-spun composite nanofibrous stationary phases have a mat thickness of ˜25 μm and an average nanofiber diameter of 380±100 nm (FIG. 9).

### Example 5

### Heat Treating

The electrospun composite PVP/SiO₂ NP nanofibers were heat treated to remove the polyvinylpyrrolidone matrix. The final temperature, ramp rate, hold time, and electrospinning time were investigated to maximize the amount of PVP removed from the nanofibers while maintaining various characteristics in the resulting surface that were optimal for UTLC. Such characteristics in the post-processed mat included a large enough area for UTLC separations (at least 2 cm×4 cm), adhesion of the mat to a solid support such as the shim stock, and the highest degree of strength and robustness, to name a few.

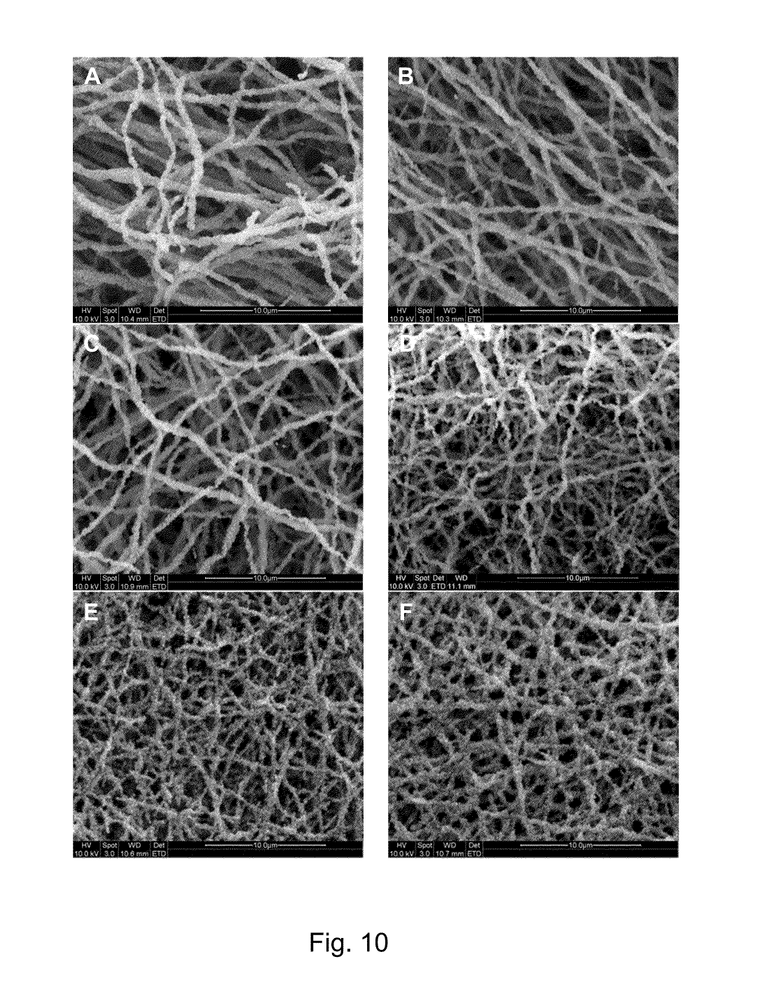

Final temperatures of 350° C., 400° C., 450° C., 465° C., 475° C., and 500° C. were investigated. As shown in FIG. 10, close-packed SiO₂ NP nanofibrous structures remained after heat treatment. PVP begins to degrade at ˜250° C. and continues to decompose up to ˜450 to 500° C. Even at the lowest final temperature examined, this degradation was apparent; the nanofibers took on a more textured morphology as the polyvinylpyrrolidone was removed and the SiO₂ NPs were exposed. The nanofibrous morphology of the electrospun samples was maintained after heat treatment. The nanofibers heated to final temperatures of 475° C. and 500° C. appeared to be more densely packed (FIGS. 10E and 10F, respectively) than the nanofibers heated to lower final temperatures; macroscopically, they also appeared whiter and much more brittle. This can be attributed to more of the polyvinylpyrrolidone matrix being removed from the nanofibers heated to higher final temperatures.

As silica is the surface of interest for chromatographic separations, post-processed nanofibers with the minimum amount of remaining polyvinylpyrrolidone were desired. However, it must be noted that removing too much polyvinylpyrrolidone, like the nanofibers processed at 500° C., made the nanofibrous mat too brittle to use for a UTLC stationary phase. A balance needed to be found between removing the polyvinylpyrrolidone and maintaining the robustness of the post-processed mat. This was done by carefully controlling not only the final temperature to which the nanofibers were post-processed, but also by controlling the electrospinning time, ramp rate, and hold time during sample preparation and post-processing. Longer electrospinning times provide nanofibrous mats with more material; slower ramp rates allow gradual heating over time; and longer hold times increase the amount of polyvinylpyrrolidone removed from the mat.

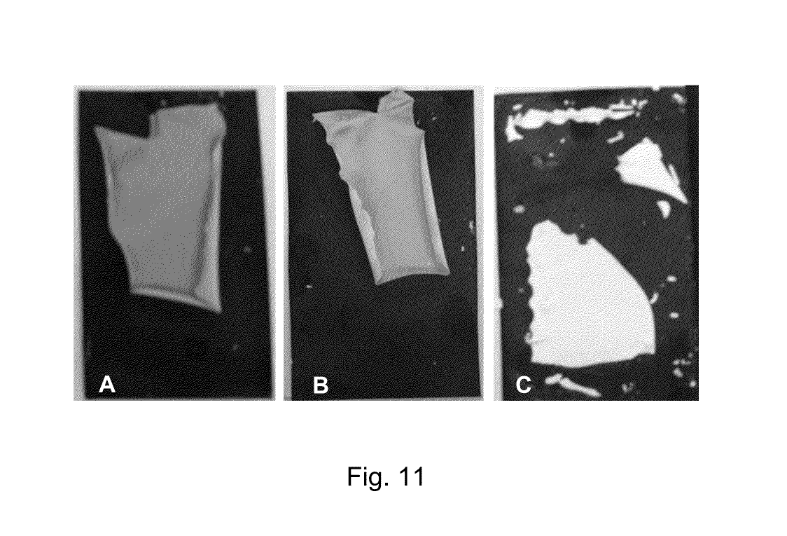

Composite mats were produced at electrospinning times ranging between 10 min to 3 h. These were heat treated to final temperatures of 450° C., 465° C., 475° C., and 500° C. using ramp rates of 0.5° C./min, 1.0° C./min, 2.0° C./min, and 5.0° C./min and were held at the final temperature for times of 2 h, 4 h, 6 h, and 8 h. Mats electrospun at 2.5 h were the least brittle. Using a ramp rate of 0.5° C./min kept the mats relatively flat and free from fractures. Mats heat treated to a final temperature of 450° C. were quite dark compared to higher temperatures (FIG. 11A); not only would this make analyte visualization more difficult during UTLC, but also these mats required longer hold times. Mats heat treated to a final temperature of 475° C. were too brittle regardless of the electrospinning time, ramp rate or hold time (FIG. 11C). Therefore, optimum post-processing parameters were determined to be an electrospinning time of 2.5 h, a final temperature of 465° C., and a ramp rate of 0.5° C./min (FIG. 11B); using these conditions, a hold time of 6 h proved to be sufficient (no significant change in mat color or brittleness with longer hold times than 6 h).

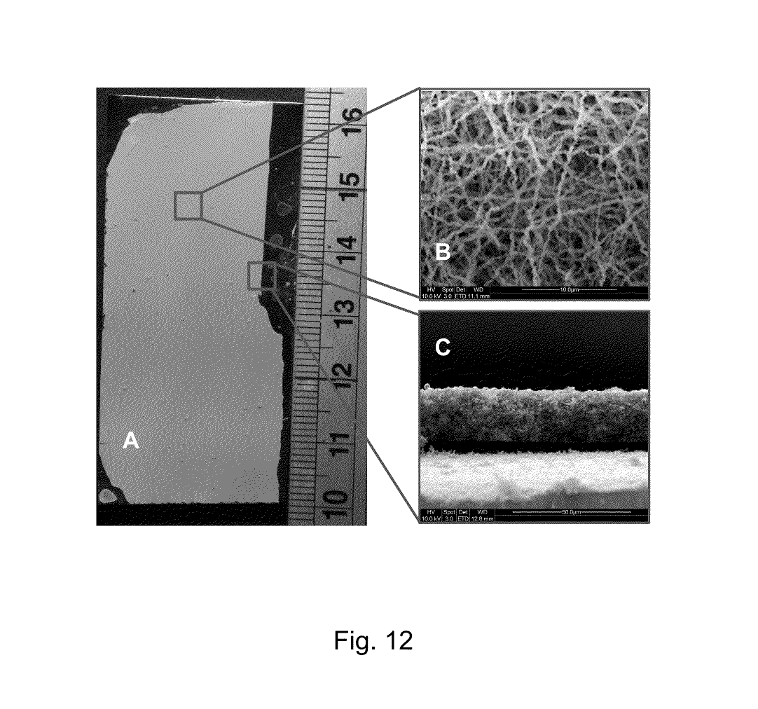

Once post-processed, the edges of the resulting mat were curled and the entire mat no longer adhered to the original stainless steel substrate. The curly edges of the mat were trimmed off, and methanol was used to re-wet the post-processed sample on a clean piece of stainless steel shim stock; this allowed an even mat to be re-adhered to a substrate for subsequent UTLC separations (FIG. 12A). Compared to the heat-treated nanofibers (FIG. 10D), no change in the morphology of the post-processed nanofibers was observed after re-adhesion to the substrate using methanol (FIG. 12B).

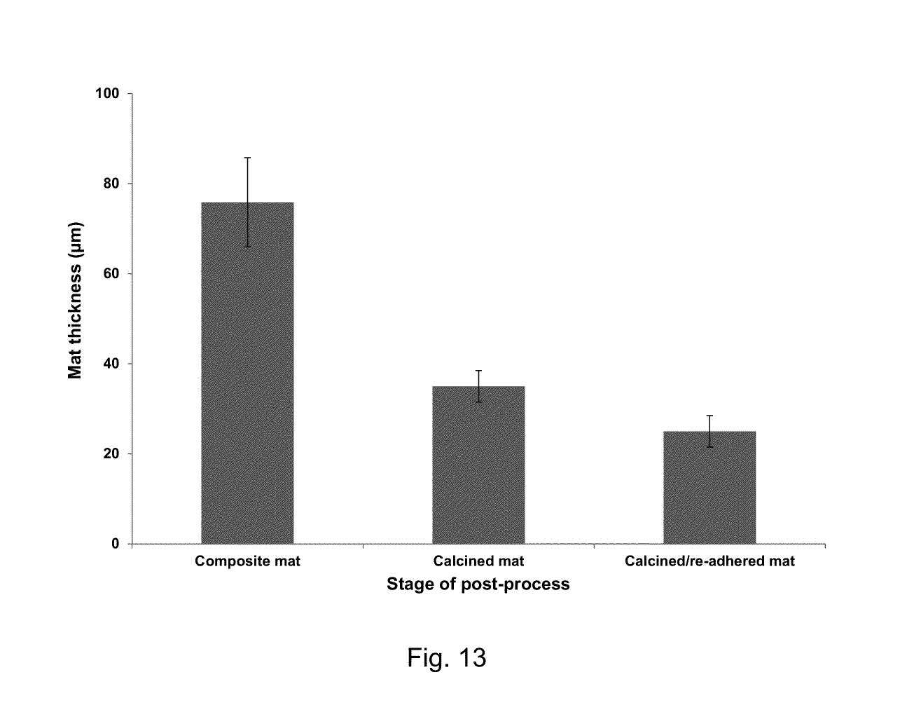

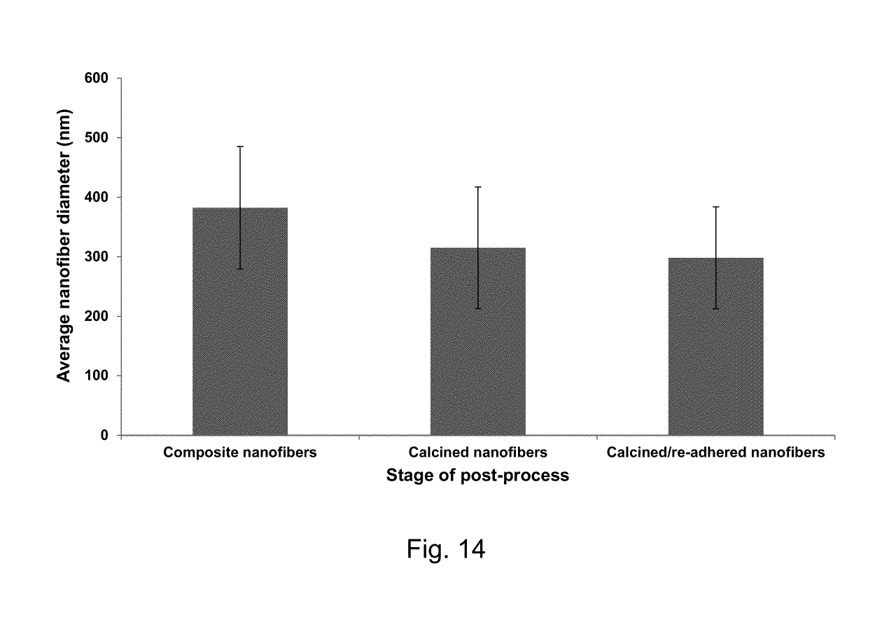

The mat thickness and nanofiber diameter were analyzed throughout the different post-processing steps. Mat thicknesses and nanofiber diameters are compared in FIG. 13 and FIG. 14, respectively. The original composite PVP/SiO₂ NP nanofibrous mat spun for 2.5 h had a mat thickness of ˜80 μm and an average nanofiber diameter of 380±100 nm. Once heat treated using optimized post-processing conditions, the mat thickness decreased by ˜50% (˜35 μm mat thickness) and the average nanofiber diameter decreased by ˜20% (315±100 nm). Both the mat thickness and average nanofiber diameter remained relatively the same after re-adhering to the solid support with methanol (˜25 μm and 300±90 nm, respectively).

### Example 5

### Separation of Laser Dyes

A set of three laser dyes, rhodamine 610 perchlorate, rhodamine 610 chloride, and pyrromethene 597, was separated on as-spun and post-processed PVP/SiO₂ NPs nanofibrous UTLC plates. This qualitative experiment was performed to verify that both the as-spun and post-processed nanofibrous stationary phases were suitable for UTLC separations. Both stationary phases were suitable for UTLC separations. The retardation factors, R_{f}, for these analytes on the as-spun nanofibrous UTLC plates were calculated (Equation 2) and listed in Table I.

TABLE I

| | As-spun plate R_{f} | As-spun plate R_{f} |
|---|---|---|
| | (% RSD) | (% RSD) |
| | EtOAc/Heptane | EtOAc/Heptane |
| Analyte | (10/90) | (20/80) |
| Rhodamine 610 chloride | 0.77 (3.7) | 0.91 (2.0) |
| Rhodamine 610 perchlorate | 0.78 (3.0) | 0.92 (1.9) |
| Sulforhodamine 640 | 0.99 (0.7) | 0.99 (1.4) |

### Prophetic Example

A mixture of acebutolol, propranolol, and cortisone will be studied using both the composite (as-spun) nanofiber and the silica (post-processed) nanofiber plates. These compounds will be analyzed at the lowest concentrations that can be utilized while allowing for post-development visualization.

In order to demonstrate the efficacy of using electrospun silica nanofibers as a chromatographic stationary phase, a mixture of four laser dyes, rhodamine 610 chloride, rhodamine 610 perchlorate, sulforhodamine 640, and kiton red, will be applied to the UTLC plates. The retardation factor, R_{f} (Equation 2), for each of these compounds will be calculated.

$${R}_{f} = \frac{{Z}_{s}}{{Z}_{f}} \qquad ( 2 )$$

The electrospun UTLC devices described herein proved to be chemically and mechanically robust over a large number of experiments. Each plate was used for at least 3-15 trials before performance or physical structure diminished. After the plates were no longer usable, the nanofiber stationary phase was simply removed by scrubbing the substrate and then cleaned with acetone. A new device for UTLC could then be created by electrospinning onto the reusable substrate.

What is claimed is:

1. An ultrathin-layer chromatography plate comprising a stationary phase including electrospun nanofibers comprising silica, wherein the stationary phase has a thickness from about 10 μm to about 30 μm.

2. The ultrathin-layer chromatography plate of claim 1, wherein the nanofibers comprise at least about 90% silica.

3. The ultrathin-layer chromatography plate of claim 1, wherein the nanofibers comprise at least about 95% silica.

4. The ultrathin-layer chromatography plate of claim 1, wherein the nanofibers further comprise polyvinylpyrrolidone.

5. The ultrathin-layer chromatography plate of claim 1, wherein the nanofibers have an average diameter from about 200 nm to about 750 nm.

6. The ultrathin-layer chromatography plate of claim 1, wherein the nanofibers have an average diameter from about 300 nm to about 500 nm.

7. The ultrathin-layer chromatography plate of claim 1, wherein the stationary phase has a length and a width, and the thickness of the stationary phase is substantially consistent along its entire length and width.

8. A method of making an ultrathin-layer chromatography plate having a stationary phase comprising nanofibers comprising silica, the method comprising:
electrospinning a solution comprising polyvinylpyrrolidone and silica nanoparticles to form a mat comprising polyvinylpyrrolidone-silica composite nanofibers; and
heat treating the mat to form the stationary phase.

9. The method of claim 8, wherein the composite nanofibers have an average diameter from about 200 nm to about 1 μm.

10. The method of claim 8, wherein the mat has a thickness from about 30 μm to about 150 μm.

11. The method of claim 8, wherein the stationary phase has a thickness from about 10 μm to about 30 μm.

12. The method of claim 8, wherein the nanofibers comprise at least about 90% silica.

13. The method of claim 8, wherein the nanofibers comprise at least about 95% silica.

14. The method of claim 8, wherein the nanofibers have an average diameter from about 200 nm to about 750 nm.

15. The method of claim 8, wherein the nanofibers have an average diameter from about 300 nm to about 500 nm.

16. The method of claim 8, wherein the solution comprises from about 1 wt % to about 20 wt % polyvinylpyrrolidone and from about 1 wt % to about 15 wt % silica nanoparticles.

17. The method of claim 8, wherein the solution comprises from about 3 wt % to about 10 wt % polyvinylpyrrolidone and from about 2 wt % to about 10 wt % silica nanoparticles.

18. The method of claim 8, wherein the solution comprises from about 4 wt % to about 8 wt % polyvinylpyrrolidone and from about 3 wt % to about 7 wt % silica nanoparticles.

19. The method of claim 8, wherein the heat treating step is performed at a temperature from about 100° C. to about 470° C.

20. The method of claim 8, wherein the heat treating step is performed for a length of time greater than about 1 hour.
